(19) United States
(12) Patent Application Publication
(10) Pub. No.: US 2007/0024592 A1
(43) Pub. Date: Feb. 1, 2007

(54) Touch sensor circuitry and system

(75) Inventor: Charles David Fry, New Bloomfield, PA (US)

Correspondence Address: Helen Odar Wolstoncroft, Suite 140, Tyco Electronic 4550 New Linden Hill Road, Wilmington, DE, 19808-2952, US

(73) Assignee: Tyco Electronics Corporation

(21) Appl. No.: 11/190,759

(22) Filed: Jul. 27, 2005

(51) Int. Cl. G09G 5/00

(52) U.S. Cl. 345/173

(57) ABSTRACT

A touch sensor includes a touch pad; and a circuit configured to detect radiated energy from the touch pad. An impedance connected in series with the touch pad in the circuit, and the impedance selected to approximately match the impedance of a human finger in proximity to the touch pad. The sensor does not require floating power supplies and ground references, and does not rely upon a receiver in the circuit to detect radiated energy.

### BACKGROUND OF THE INVENTION

This invention relates generally to touch sensitive control interfaces, and more particularly, to a touch sensor system for use in such interfaces.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, vending machines, and even toys. The associated device may be finger operated by touching predefined areas of the interface, and the device typically includes a controller coupled to the interface to operate mechanical and electrical elements of the device in response to user commands entered through the touch control interface.

Certain known touch sensors depend upon a radiated signal and a receiver to detect the radiated signals as the users approach the sensors. Other known touch sensors depend on the user's body to reduce the coupled strength to the receiver, and detect user touches by sensing the amount of the output power that is redirected to the user. Still other touch sensors depend on the body acting as a coupling mechanism that increases the received power, and by sensing the power of signals received, touches can be detected.

Other types of touch sensors attempt to detect touches by measuring a change in capacitance at the touch interface. The capacitances involved, however, are tiny, and the methods of measuring capacitance tend to be easily affected by noise or even surface contamination.

U.S. Pat. No. 5,760,715 describes capacitive touch sensors that complete a circuit to earth ground when a user's finger is adjacent the sensor. The sensors, however, require a power supply that is decoupled from ground, and such a floating power supply and/or virtual ground reference complicates the installation of the sensors in certain devices. The entire system must float to the touch system's reference point, and consequently some type of signal level conversion must be provided in such systems. Additionally, such sensors require opto-isolators and the like which add to the expense of the sensors.

It would be desirable to provide a lower cost touch sensor system that may reliably detect touches with a reduced number of components, and while avoiding the installation difficulties of floating power supplies and/or floating ground references.

### BRIEF DESCRIPTION OF THE INVENTION

According to an exemplary embodiment, a touch sensor comprises a touch pad; and a circuit configured to detect radiated energy from the touch pad. Optionally, an impedance is connected in series with the touch pad in the circuit, and the impedance is selected to approximately match the impedance of a human finger in proximity to the touch pad. Current is transmitted through the impedance when the touch pad is touched by a user, and substantially no current flows through the impedance when the touch pad is not touched by a user.

In another embodiment, a touch based control system comprises a touch pad, a circuit configured to detect radiated energy from the touch pad without utilizing a receiver in the circuit, and a controller coupled to the circuit and monitoring a detected output from the circuit.

In still another embodiment, a touch based control system for a device having operative components connected to a device controller is provided. The system comprises a control interface defining at least one touch sensitive area, and a touch sensitive element associated with the touch sensitive area, and the touch sensitive element comprises a touch pad, and a circuit configured to detect radiated energy from the touch pad without utilizing a receiver in the circuit, and an impedance connected in series with the touch pad in the circuit, the impedance selected to approximately match the impedance of a human finger in proximity to the touch pad.

### BRIEF DESCRIPTION OF THE DRAWINGS

FIG. 1 is a schematic block diagram of an exemplary touch sensitive control system for a device.

FIG. 2 is a top plan view of an exemplary control interface for the control system shown in FIG. 1.

FIG. 3 is a circuit schematic of a touch sensor for use with the system shown in FIG. 1 and the interface shown in FIG. 2.

FIGS. 4a-4d are scope outputs of the circuit shown in FIG. 3 under different operation conditions.

FIG. 5 is a block diagram of the controls for the system shown in FIG. 1.

FIG. 6 is a block diagram of an alternative embodiment of the controls for the system shown in FIG. 1.

FIG. 7 is another circuit schematic of a touch sensor for use with the system shown in FIG. 1 and the interface shown in FIG. 2.

FIG. 8 is a simulated output response of the circuit shown in FIG. 7 under different operating conditions.

FIG. 9 is a circuit schematic of a sensor array according to the present invention.

### DETAILED DESCRIPTION OF THE INVENTION

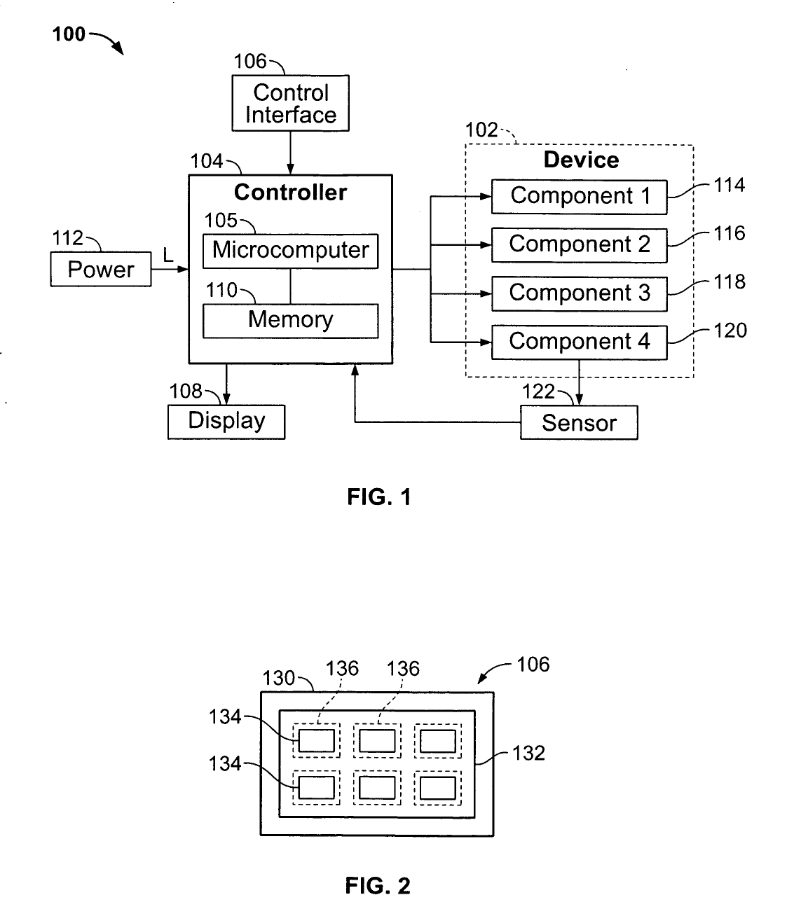

FIG. 1 is a schematic block diagram of an exemplary touch sensitive control system 100 for a device 102, which in various embodiments may be an appliance, an industrial machine or any other device in which a touch sensitive control interface is desirable.

In an exemplary embodiment, the control system 100 includes a controller 104 which may, for example, include a microcomputer or other processor 105 coupled to a user control interface 106 including one or more touch sensitive elements as described further below. An operator may enter control parameters, instructions, or commands and select desired operating algorithms and features of the device 102 via user interface input 106. In one embodiment a display or indicator 108 is coupled to the controller 104 to display appropriate messages and/or indicators to the operator of the device 102 to confirm user inputs and operation of the device 102. A memory 110 is also coupled to the controller 104 and stores instructions, calibration constants, and other information as required to satisfactorily complete a selected user instruction or input. Memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Power to control system 100 is supplied to controller 104 by a power supply 112 configured to be coupled to a power line L. Analog to digital and digital to analog converters (not shown) are coupled to the controller 104 to implement controller inputs and executable instructions to generate controller outputs to operative components 114, 116, 118 and 120 of the device 102 according to known methods. While four components 114, 116, 118, and 120 are illustrated in FIG. 1, it is recognized that greater or fewer components may be employed within the scope of the present invention.

In response to manipulation of the control interface 106, the controller 104 monitors various operational factors of the device 102 with one or more sensors or transducers 122, and the controller 104 executes operator selected functions and features according to known methods.

FIG. 2 is a top plan view of an exemplary control interface 106 for the control system 100 (shown in FIG. 1). The interface 106 includes a panel 130 which defines an interface area 132 for manipulation by a user to enter control commands and instructions for the device 102 (shown in FIG. 1). In different embodiments, the panel 130 may be mounted proximate the operative components 114-120 (e.g., dispensing components) of the device 102 (such as in a vending machine), or the panel 130 may be located in a remote location from the components 114-120 (such as for moving components of an industrial machine).

The panel 130 further includes touch sensitive areas 134 arranged in the interface area 132 for user selection and manipulation to enter commands to operate the device 102. While six touch sensitive areas 134 (corresponding to two rows and three columns of areas illustrated in FIG. 2) are provided in an illustrative embodiment, in alternative embodiments more or less touch sensitive areas 134 may be included in the interface area 106.

Associated with each of the touch sensitive areas 134 are touch sensitive elements 136 (shown in phantom in FIG. 2). The elements 136, and the controller 104 are configured to detect an actual touch, also referred to herein as a touch detection or touch result, at the associated touch sensitive areas 134. Unlike known switching elements (e.g., membrane switch assemblies), touches are detected electronically, and actual mechanical or electrical switching of a conductive path, and associated reliability issues thereof, is avoided. Moreover, and as explained below, touches are detected without using floating power supplies and/or ground references, and without using a receiver which some known touch sensors employ. Touch sensing may therefore be provided at a lower cost with easier installation than known touch based systems.

While one control interface 106 is illustrated having one exemplary matrix or array of touch sensitive areas 134, it is understood that the control system 100 may have more than one control interface 106, and each control interface 106 may have one or more interface areas 132. Further, each interface area 132 may include more or less touch sensitive areas 134 corresponding to more or less touch sensitive elements 136 as shown in FIG. 2.

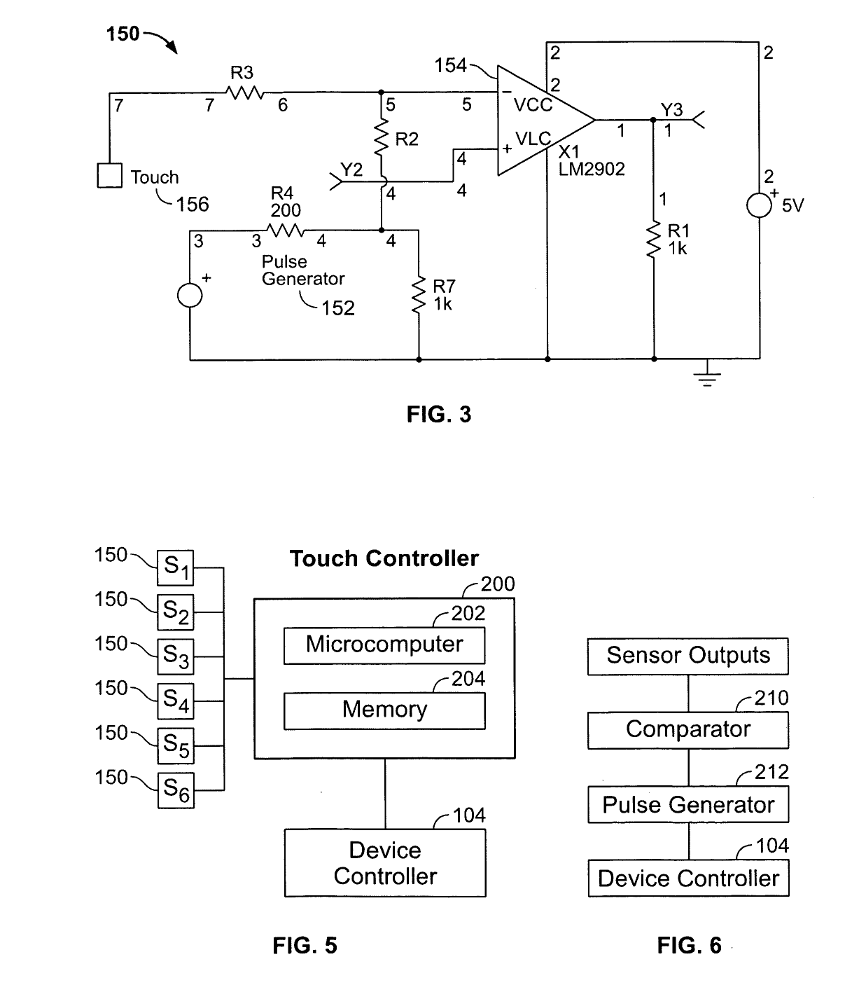

FIG. 3 is a circuit schematic of a touch sensor 150 which may serve as the touch sensitive element 136 in the system 100 shown in FIG. 1 and the 106 interface shown in FIG. 2. Unlike some known touch sensors, the sensor 150 operates without a receiver and without floating power supplies and/or ground references. Rather, as explained below, the sensor 150 indicates a change in radiated power to reliably detect user touches in a cost effective manner, without requiring a receiver in the circuit.

As shown in FIG. 3, the sensor 150 includes a pulse generator 152, an op amp 154, a touch pad 156 that in one embodiment is a capacitive element touch sensor element known in the art, and series resistance R3 connected to a first input of the op amp 154. A resistor R2 is connected across the inputs of the op amp 154, and a biasing resistor R1 is connected in series with the op amp output. When a user touches the touchpad 156, a circuit is completed through the touch pad 156 and current flows through R3 and R2. The voltage across the resistor R2 is amplified and output across the biasing resistor R1. By sensing the voltage across the op amp output, touches to the touch pad 156 may be detected in the manner explained below. The sensor 150 may be used as a stand alone circuit, or may be electrically connected to other sensors 150 in an array for a control interface having multiple sensors 150

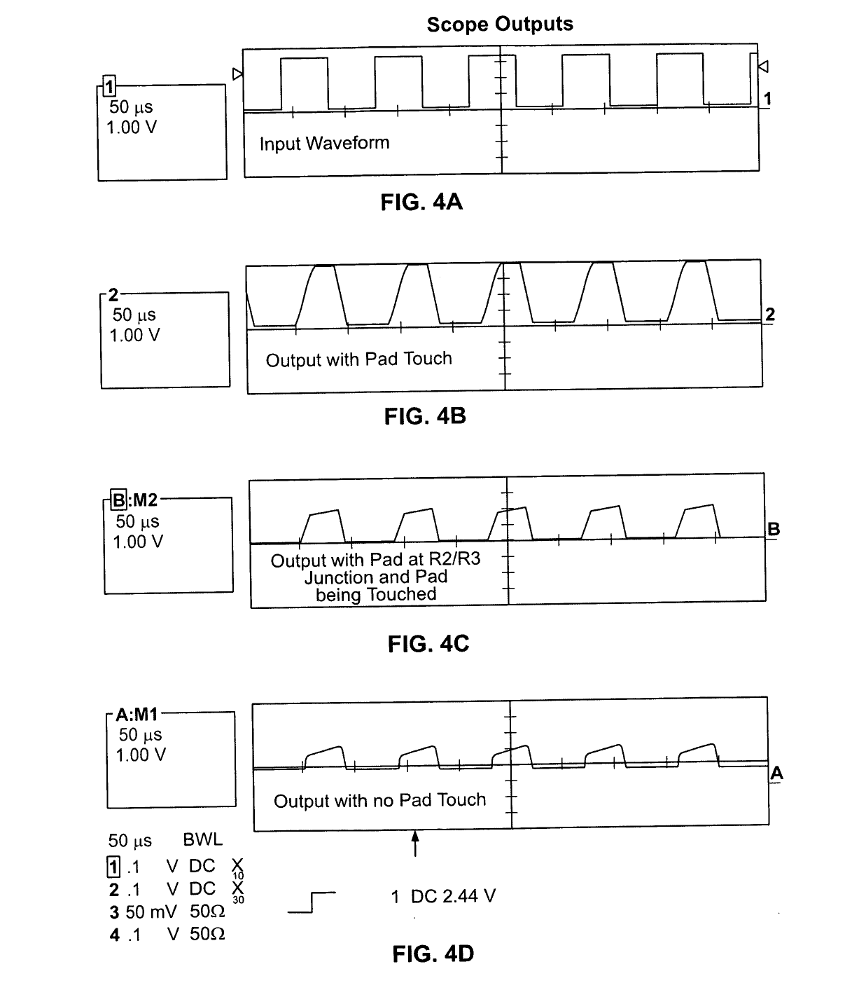

FIGS. 4a-4d are scope outputs of the circuit shown in FIG. 3 under different operation conditions.

FIG. 4a represents the input signal generated by the pulse generator 152, and in one embodiment is a square waveform or step input of a predetermined magnitude. The pulse generator 152 produces the input waveform on a periodic basis as shown in FIG. 4a.

FIG. 4b represents the output signal of the op-amp, in response to the input pulse signal of the generator 152, when the touch pad 156 is touched by a user. As seen in FIGS. 4a and 4b, the output signal slightly lags the input signal, but has a similar periodicity and magnitude such that the output signal may be readily detected by sensing the output signal of the op amp 154.

FIG. 4c represents the output signal of the op-amp with the series resistance R3 shorted in the circuit of FIG. 3 and when the touch pad 156 is touched by a user. In recognition that the sensor 150 shown in FIG. 3 could be provided without the series resistance R3, FIG. 4c demonstrates that the sensor 150 is nonetheless operable without the series resistance. As seen in FIGS. 4a and 4c, the output signal slightly lags the input signal, has a similar periodicity to the input signal, but has a magnitude much less than the input signal. While the magnitude of the output signal in FIG. 4c is much less than the magnitude of the output signal shown in FIG. 4b with the series resistance R3, the output signal of FIG. 4c may still be readily detected by sensing the output signal of the op amp 154.

FIG. 4d represents the output of the op-amp 154 when the touch pad 156 is not touched by a user to complete the circuit. It is seen in FIG. 4d that the output of the op amp 154 without the touch pad 156 being touched is different in form than either of the output signals in FIGS. 4b and 4c when the touch pad 156 is touched. Thus, by establishing a baseline output signal of, for example, FIG. 4d, the output waveforms of FIGS. 4b and 4c may be compared to the baseline signal output to determine whether the touch pad 156 has been touched or activated by a user.

It is believed that the series resistance R3 acts as a broadband series impedance approximately matching the effective antenna of the human touch. The reduced output levels of FIG. 4c show that this is indeed the case. If the additional series resistance R3 was just slowing the decay of the voltage across a capacitance, then the voltage divider formed by R3 and R2 would have reduced the peak output amplitude instead of the exhibited increase in the peak output amplitude. While R3 is believed to be desirable due to the increased output amplitude of the op amp 154, R3 is optional and may not be included in some embodiments of the invention.

Referring back to FIG. 3, the pulse generator 152 formed by the voltage source and R4, representing an approximate internal resistance of the generator 152, generates a wideband input signal to the touch pad 156. If the input signal is not radiated from the pad 156, little or no current will flow through R2 and the differential voltage input to the op amp 154 will be approximately zero. As a result, the output of the op amp 154 will also be approximately zero for an input pulse.

However, when an antenna (i.e., the human finger) is connected to the opposite terminal of R2, a wideband transmission occurs across the touch pad 156 which forces the equivalent current to flow through R2. This current through R2 then produces a differential voltage at the input of the op amp 154, and an amplified form of the radiated current will be seen on the output of the op amp 154. The addition of R3 allows the effective antenna to be better matched to the source and therefore allows for a higher radiated power level with the resulting higher current. The selection of R2 and R3 may be dependent on pad size, isolation dielectric, and op amp characteristics (such as gain-bandwidth product and slew rate). In an exemplary embodiment, R2 is approximately 250 kΩ, and R3 is approximately 1000 kΩ, although it is recognized that greater or lesser resistance values could be employed for R2 and R3 in other embodiments.

FIG. 5 is a block diagram of the controls for the system shown in FIG. 1 including a touch controller 200 in communication with each of the sensors 150 (designated S_{I} though S₆ in FIG. 5), and operationally connected to the device controller 104. Like the device controller 104, the touch controller 200 includes a microcomputer 202 or other processor coupled to the user control interface 106, and a memory 204 that stores instructions, calibration constants, control algorithms, and other information as required to satisfactorily interface with the device controller 104. Memory 204 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

The touch controller 200 measures the output of the op amp 154 (FIG. 3) of each sensor 150 at the appropriate time, and in one embodiment, the controller 200 sequentially pulses the sensors 150 to provide a full array of touch pads for user touch activation. If, in response to the input pulses, the measured power level output from the respective op amp exceeds a predetermined threshold, a pad touch detection is indicated, and the touch controller 200 signals the device controller 104 accordingly. In further embodiments, the touch controller 200 can perform noise elimination, signal type conversion, and other functions as desired.

While the touch controller 200 is separately illustrated in FIG. 5 from the device controller 104, it is contemplated that the functionality of the touch controller could be integrated into the device controller 104 in other embodiments, and a dedicated touch controller is therefore considered optional to the present invention.

In a simpler form, as illustrated in FIG. 6, a threshold comparator 210 could be placed on the outputs of the sensors 150, with an output pulse generated by a pulse generator 212 to the device controller 104 for a touch (i.e., signal output exceeding the threshold) and no pulse generated when the signal output is less than the threshold. Thus, in such an embodiment, the signal comparison is made without the aid of a controller.

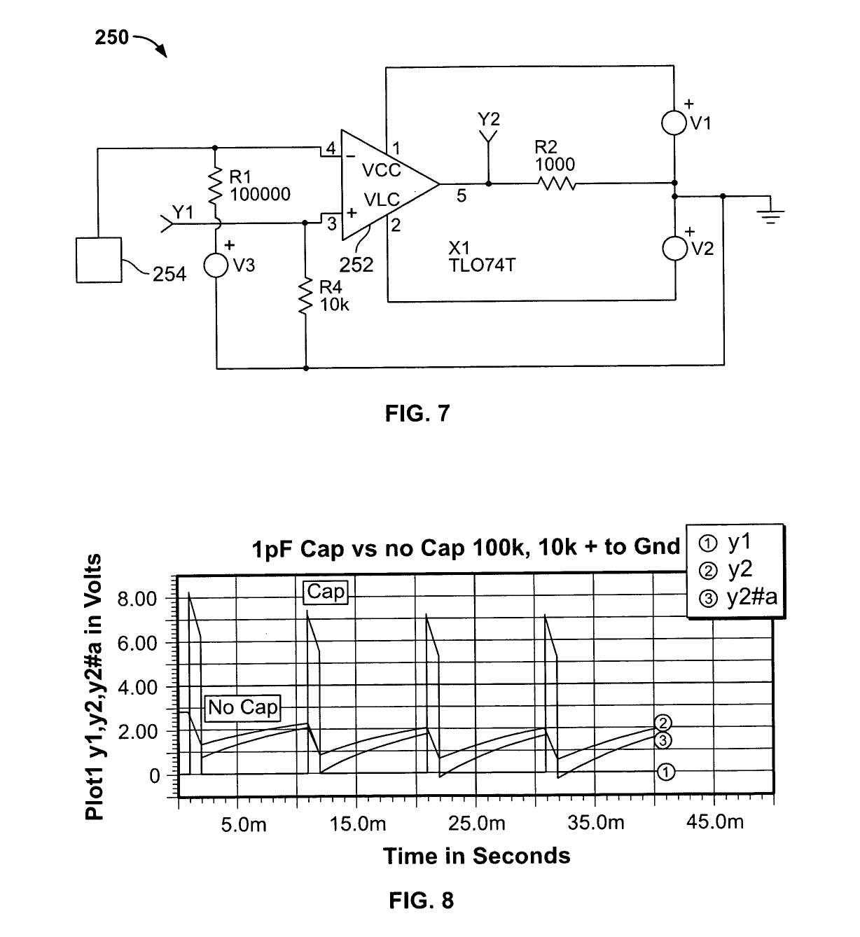

FIG. 7 is another circuit schematic of a touch sensor 250 for use with the system 100 (FIG. 1) and the interface 106 (FIG. 2). Like the sensor 150 described above, the sensor 250 operates without a receiver and without floating power supplies and/or ground references. Rather, as explained below, the sensor 250 indicates a change in radiated power to reliably detect user touches in a cost effective manner.

As shown in FIG. 7, the sensor 250 includes an op amp 252, a touch pad 254, a resistor R1 connected across the inputs of the op amp 252, a load resistance R2 for output of the op amp 252, and a biasing resistor R4 connected to one of the inputs of the op amp 252. When a user touches the touchpad 254, a circuit is completed through the touch pad 254 and current flows through R1 and R4. The voltage across the resistor R1 is amplified and output across the resistor R2. By sensing the voltage across the op amp output, touches to the touch pad 254 may be detected in the manner explained below. The sensor 250 may be used as a stand alone circuit, or be electrically connected to other sensors 250 in an array for a control interface having multiple sensors 250.

Operationally, the sensor 250 functions much like the sensor 150 previously described, and can be controlled with a dedicated controller similar to the embodiment of FIG. 5 or without the aid of a controller similar to the embodiment of FIG. 6.

FIG. 8 is a simulated output response of the circuit shown in FIG. 7, illustrating a baseline input signal 3 provided by, for example, a pulse generator, an output signal 2 with no touch to the touch pad 254, and an output signal 1 when the touch pad 254 is touched. As FIG. 8 demonstrates, the touch signal 1 is easily detected using the sensor 250.

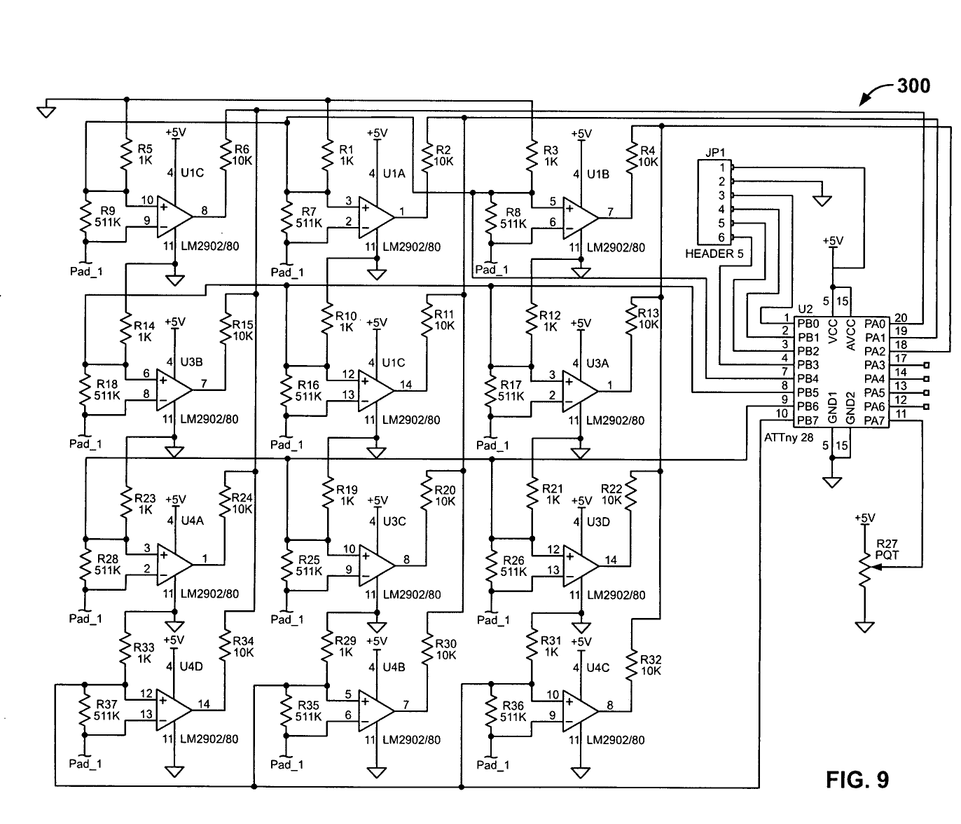

FIG. 9 is a circuit schematic of a sensor array 300 according to the present invention including multiple sensors interconnected with one another, and each of the sensors associated with a touch pad of the interface. The sensors are individually constructed and operated according to the examples described above. The exemplary embodiment shown in FIG. 9 is illustrated without a series impedance for the sensors, although it is recognized that a series impedance for the sensors could be provided in an alternative embodiment.

While the invention has been described in terms of various specific embodiments, those skilled in the art will recognize that the invention can be practiced with modification within the spirit and scope of the claims.

What is claimed is:

1. A touch sensor comprising:
a touch pad; and
a circuit configured to detect radiated energy from the touch pad.

2. A touch sensor in accordance with claim 1 further comprising an impedance connected in series with said touch pad in said circuit, said impedance selected to approximately match the impedance of a human finger in proximity to the touch pad.

3. A touch sensor in accordance with claim 2 wherein current is transmitted through said impedance when said touch pad is touched by a user, and wherein substantially no current flows through the impedance when the touch pad is not touched by a user.

4. A touch sensor in accordance witch claim 1 further comprising an amplifier and a resistance connected across inputs to the amplifier, said amplifier inputs further connected to said touch pad, said amplifier configured to detect current transmitted through said touch pad when touched by a user.

5. A touch sensor in accordance with claim 1 further comprising an amplifier providing a voltage output, and a comparator configured to determine whether the voltage input exceeds a predetermined voltage threshold corresponding to a touch of the touch pad.

6. A touch sensor in accordance with claim 1 further comprising a pulse generator driving the circuit.

7. A touch based control system comprising:
a touch pad;
a circuit configured to detect radiated energy from the touch pad without utilizing a receiver in the circuit; and
a controller coupled to the circuit and monitoring a detected output from the circuit.

8. A touch based control system in accordance with claim 7 further comprising an impedance connected in series with said touch pad in said circuit, said impedance selected to approximately match the impedance of a human finger in proximity to the touch pad.

9. A touch based control system in accordance with claim 7 wherein current is transmitted through said impedance when said touch pad is touched by a user, and wherein substantially no current flows through the impedance when the touch pad is not touched by a user.

10. A touch based control system in accordance witch claim 7 further comprising an amplifier and a resistance connected across inputs to the amplifier, said amplifier inputs further connected to said touch pad, said controller monitoring an output of said amplifier to detect whether a touch pad is touched by a user.

11. A touch based control system in accordance with claim 10 said controller configured to determine whether the voltage output of the amplifier exceeds a predetermined voltage threshold corresponding to a touch of the touch pad.

12. A touch based control system in accordance with claim 7 further comprising a pulse generator driving the circuit.

13. A touch based control system in accordance with claim 7 wherein said system comprises a plurality of touch pads interconnected in an array, a circuit associated with each touch pad, said controller configured to detect radiated energy from the touch pads without utilizing a receiver in the circuit

14. A touch based control system for a device having operative components connected to a device controller, said system comprising:
a control interface defining at least one touch sensitive area, and a touch sensitive element associated with the touch sensitive area, said touch sensitive element comprising:
a touch pad, and a circuit configured to detect radiated energy from the touch pad without utilizing a receiver in the circuit; and
an impedance connected in series with said touch pad in said circuit, said impedance selected to approximately match the impedance of a human finger in proximity to the touch pad.

15. A touch based control system in accordance with claim 14 wherein current is transmitted through said impedance when said touch pad is touched by a user, and wherein substantially no current flows through the impedance when the touch pad is not touched by a user.

16. A touch based control system in accordance witch claim 14 further comprising an amplifier and a resistance connected across inputs to the amplifier, said amplifier inputs further connected to said touch pad, an output of said amplifier being monitored and compared to a predetermined threshold to indicate a touch to the device controller.

17. A touch based control system in accordance with claim 14 further comprising a controller configured to determine whether the voltage output of the amplifier exceeds a predetermined voltage threshold corresponding to a touch of the touch pad.

18. A touch based control system in accordance with claim 14 further comprising a pulse generator driving the circuit.

19. A touch based control system in accordance with claim 14 wherein said interface comprises a plurality of touch sensitive areas each associated with a touch sensitive element, having a touch pad, the touch pads being interconnected in an array, and a circuit associated with each touch pad, wherein a touch signal is sent to the device control when a voltage output associated with the touch pads exceeds a predetermined voltage threshold.

20. A touch based control system in accordance with claim 14 further comprising a touch controller separately provided from the device controller, said touch controller monitoring a voltage output of the circuit and signaling the device controller when a threshold voltage level is exceeded.

21. A touch sensor in accordance with claim 1, wherein said sensor comprises a plurality of touch pads interconnected in an array, and a circuit associated with each touch pad, said controller configured to detect radiated energy from the touch pads without utilizing a receiver in the circuit
